(19) United States
(12) Patent Application Publication
(10) Pub. No.: US 2013/0077165 A1
(43) Pub. Date: Mar. 28, 2013

(54) VEHICLE DISPLAY MIRROR AND METHOD OF MANUFACTURING THE SAME

(71) Applicants: CHAO-YING LIN, NEW TAIPEI CITY (TW); JEN-HUAI CHANG, TAOYUAN COUNTY (TW)

(72) Inventors: CHAO-YING LIN, NEW TAIPEI CITY (TW); JEN-HUAI CHANG, TAOYUAN COUNTY (TW)

(73) Assignee: EXTEND OPTRONICS CORP., TAOYUAN COUNTY (TW)

(21) Appl. No.: 13/239,747

(22) Filed: Sep. 22, 2011

(51) Int. Cl. G02B 27/28; B32B 38/10

(52) U.S. Cl. 359/489.19; 156/244.18

(57) ABSTRACT

A vehicle display mirror includes a light-polarizing reflection unit and an image display unit. The light-polarizing reflection unit includes at least one multilayer reflector composed of a plurality of inter-stacked polymer films, and at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction. The image display unit includes at least one image display screen, and the multilayer reflector is disposed on the image display screen, thus the vehicle display mirror of the instant disclosure can be used as a rear-view mirror of the vehicle and provide a clear displayed screen for user in the vehicle.

### BACKGROUND OF THE INVENTION

1. Field of the Invention

The instant disclosure relates to a vehicle display mirror and a method of manufacturing the same, and more particularly, to a vehicle display mirror as a rear-view mirror and a method of manufacturing the same.

2. Description of Related Art

Glare is one of the troublesome factors when driving a vehicle. Many efforts have been made to solve the glaring problem. One of the most effective ways is to provide an electrochromic unit for the rearview mirror of the vehicle. The electrochromic unit deepens the color and thus reduces the reflectance of the mirror according to the degree of the glare, thereby minimizing the glaring effect.

A conventional anti-glare rearview mirror includes a photo-detector mounted on an electrochromic rearview mirror, and oriented to detect rearward light. The photo-detector outputs a control signal to the electrochromic rearview mirror to adjust the reflectance of the mirror according to the intensity of the rearward light. For example, for an intense rearward light, the reflectance of the mirror is required to be lowered. That is, the color of the mirror is deepened in order to avoid irritating to the driver's eyes.

### SUMMARY OF THE INVENTION

One aspect of the instant disclosure relates to a vehicle display mirror and a method of manufacturing the same. The vehicle display mirror can be used as a rear-view mirror of the vehicle and provide a clear displayed screen for user in the vehicle.

One of the embodiments of the instant disclosure provides a vehicle display mirror, comprising: a light-polarizing reflection unit and an image display unit. The light-polarizing reflection unit includes at least one multilayer reflector composed of a plurality of inter-stacked polymer films, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction. The image display unit includes at least one image display screen, wherein the at least one multilayer reflector is disposed on the at least one image display screen.

Furthermore, the light-polarizing reflection unit includes a first substrate, a second substrate, a first functional layer, and a second functional layer. For example, the instant disclosure has at least four embodiment, as follows: (1) the first functional layer and the second functional layer may be respectively disposed on a first surface and a second surface of the at least one multilayer reflector; (2) the first functional layer and the second functional layer may be respectively disposed on a first surface and a second surface of the at least one multilayer reflector, and the first substrate and the second substrate may be respectively disposed on the first functional layer and the second functional layer; (3) the first substrate and the first functional layer may be respectively disposed on a first surface and a second surface of the at least one multilayer reflector, and the second substrate and the second functional layer may be respectively disposed on the first functional layer and the first substrate; (4) the first substrate and the second substrate may be respectively disposed on a first surface and a second surface of the at least one multilayer reflector, and the first functional layer and the second functional layer may be respectively disposed on the first substrate and the second substrate.

Moreover, the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

Another one of the embodiments of the instant disclosure provides a method of manufacturing a vehicle display mirror, comprising the steps of: (A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction; (B) extending the at least one multilayer reflector; (C) respectively placing a first functional layer and a second functional layer on a first surface and a second surface of the at least one multilayer reflector to form a light-polarizing reflection unit; (D) adjusting the size of the light-polarizing reflection unit to conform to the size of an image display screen by cutting; and (E) adhesively placing the light-polarizing reflection unit on the image display screen.

Another one of the embodiments of the instant disclosure provides a method of manufacturing a vehicle display mirror, comprising the steps of: (A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction; (B) extending the at least one multilayer reflector; (C) respectively placing a first substrate and a first functional layer on a first surface and a second surface of the at least one multilayer reflector, and then respectively placing a second substrate and a second functional layer on the first functional layer and the first substrate, in order to form a light-polarizing reflection unit; (D) adjusting the size of the light-polarizing reflection unit to conform to the size of an image display screen by cutting; and (E) adhesively placing the light-polarizing reflection unit on the image display screen.

Another one of the embodiments of the instant disclosure provides a method of manufacturing a vehicle display mirror, comprising the steps of: (A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction; (B) extending the at least one multilayer reflector; (C) respectively placing a first substrate and a second substrate on a first surface and a second surface of the at least one multilayer reflector, and then respectively placing a first functional layer and a second functional layer on the first substrate and the second substrate, in order to form a light-polarizing reflection unit; (D) adjusting the size of the light-polarizing reflection unit to conform to the size of an image display screen by cutting; and (E) adhesively placing the light-polarizing reflection unit on the image display screen.

In conclusion, the at least one multilayer reflector composed of the inter-stacked polymer films can be disposed on the image display screen, thus the vehicle display mirror of the instant disclosure can be used as a rear-view mirror of the vehicle and provide a clear displayed screen for user in the vehicle.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a lateral, schematic view of the light-polarizing reflection unit according to the first embodiment of the instant disclosure;

FIG. 1B shows a perspective, schematic view of the vehicle display mirror according to the first embodiment of the instant disclosure;

FIG. 1C shows a flow chart of the method of manufacturing the vehicle display mirror according to the first embodiment of the instant disclosure;

FIG. 1D shows an instrument schematic diagram for manufacturing the light-polarizing reflection unit according to the first embodiment of the instant disclosure;

FIG. 2A shows a lateral, schematic view of the light-polarizing reflection unit according to the second embodiment of the instant disclosure;

FIG. 2B shows a flow chart of the method of manufacturing the vehicle display mirror according to the second embodiment of the instant disclosure;

FIG. 3A shows a lateral, schematic view of the light-polarizing reflection unit according to the third embodiment of the instant disclosure;

FIG. 3B shows a flow chart of the method of manufacturing the vehicle display mirror according to the third embodiment of the instant disclosure;

FIG. 4A shows a lateral, schematic view of the light-polarizing reflection unit according to the fourth embodiment of the instant disclosure; and

FIG. 4B shows a flow chart of the method of manufacturing the vehicle display mirror according to the fourth embodiment of the instant disclosure.

### DETAILED DESCRIPTION OF THE PREFERRED EMBODIMENTS

### First Embodiment

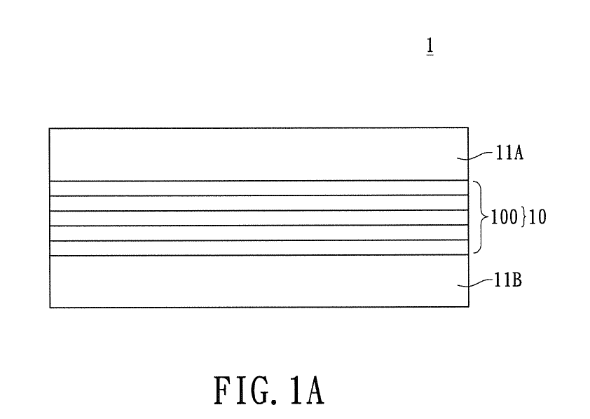

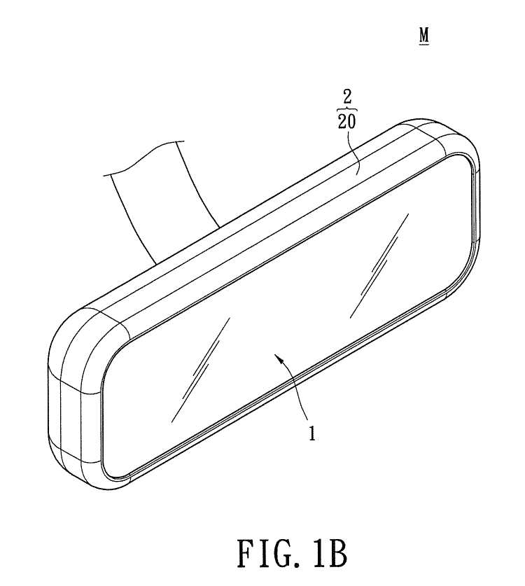

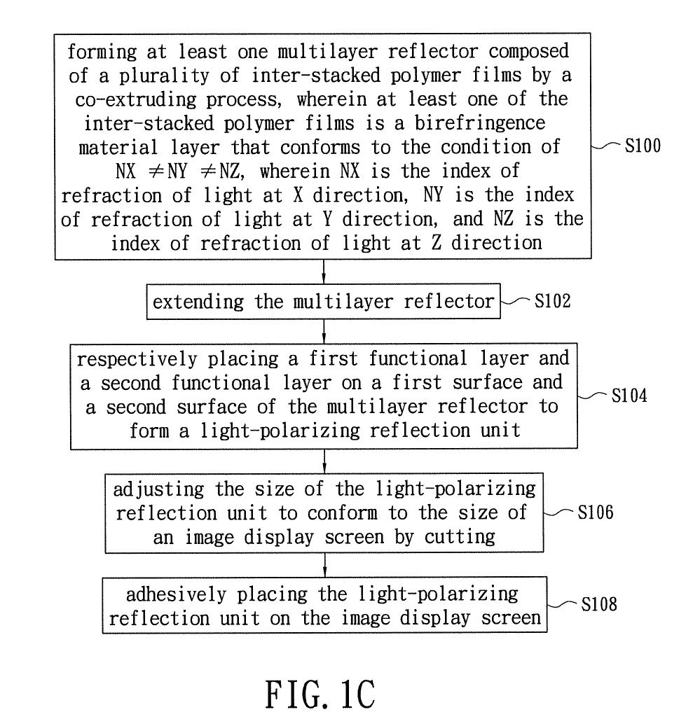

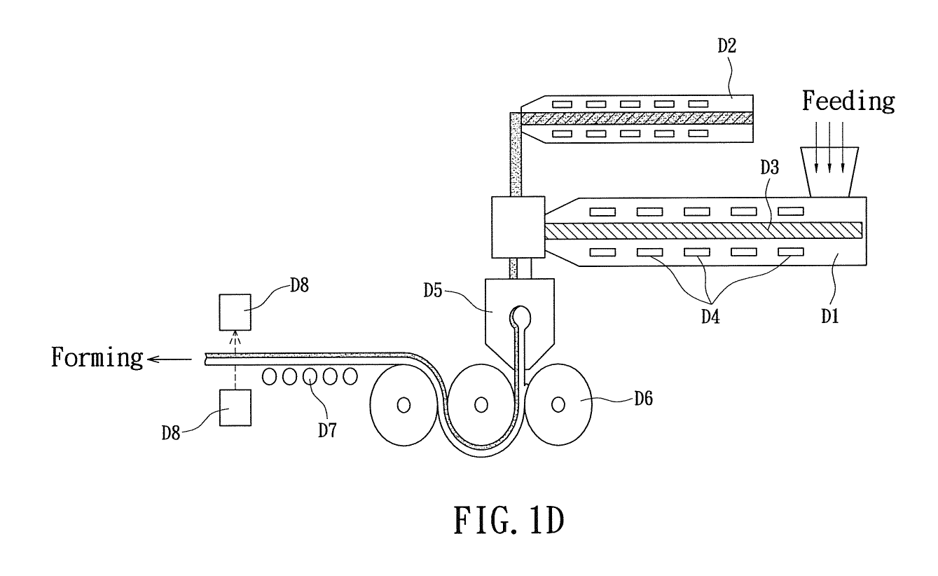

Referring to FIGS. 1A and 1B, the first embodiment of the instant disclosure provides a vehicle display mirror M, which includes: a light-polarizing reflection unit 1 and an image display unit 2. Therein, the light-polarizing reflection unit 1 includes at least one multilayer reflector 10 composed of a plurality of inter-stacked polymer films (as shown in FIG. 1A). The image display unit 2 includes at least one image display screen 20, and the multilayer reflector 10 can be disposed on the image display screen 20 (as shown in FIG. 1B). In addition, at least one of the inter-stacked polymer films 100 is a birefringence material layer that conforms to the condition of NX≠NY≠NZ, such that NX is the index of refraction of light at X direction, NY is the index of refraction of light at Y direction, and NZ is the index of refraction of light at Z direction. Moreover, the light-polarizing reflection unit 1 further includes a first functional layer 11A and a second functional layer 11B respectively disposed on a first surface and a second surface of the multilayer reflector 10. For example, the first functional layer 11A and the second functional layer 11B may be one of a metal oxide layer or an ultraviolet absorbing layer.

Furthermore, according to different operating needs, the plurality of inter-stacked polymer films 100 can be manufactured with thicker protection layer at its top or bottom surface, so as to protect the internal layers of the polymer films 100. At least one of the inter-stacked polymer films 100 is a ultra-violet reflector for reflecting ultra-violet lights, and can furthermore include a layer of infrared reflector for reflecting infrared lights. The ultra-violet reflector or infrared reflector can be composed of single-layer optical film or multi-layer optical films; which can be manufactured with multi-layer polymer films, and there can also be additions of metal oxide particles or ultra-violet absorbent; and can be placed via lamination on any surface of the inter-stacked polymer films 100 through coating, extrusion or ultra-violet paste curing. Other function layers can be added for the inter-stacked polymer films 100, such as locating a structure layer for increasing the strength and resilience, a protection layer for increasing resistance to scratch, a Nano-layer with self-cleansing effect, or locating a micro structure layer with convergence, diffraction, or diffusion capability on any surface of the inter-stacked polymer films 100. The optical microstructure layer with specific optical effect can be prism shaped, pyramid shaped, hemisphere shaped, aspheric shaped, Frensel lens shaped, lenticular, or grating structured. Furthermore, the multilayer reflector 10 can be formed through single-axial or bi-axial stretching, so that the average transmittance rate of the multilayer reflector for light spectrum 380˜780 nm is selectively between 30% and 90%, thereby effectively controls the intensity of light. Also, when the multilayer reflector 10 is formed through bi-axial stretching, then according to differences in usage needs, the multilayer reflector 10 can selectively be polarized or non-polarized.

For example, the structure of the multilayer reflector 10 is formed through many layers of material stacked in sequence of refraction rate, such as shown in FIG. 1A of the inter-stacked polymer films 100; in actuality the number of layers formed by all the inter-stacked polymer films 100 so as to make the multilayer reflector 10 can be ranged from the tens to hundreds. FIG. 1A is merely a schematic representation of the multi-layer structure, and does not show structure layers in the hundreds, and these tens to hundreds layers of inter-stacked polymer films 100 are composed of at least two types of material inter-changing in sequence; wherein the material of one of the layer conforms to the condition of NX≠NY≠NZ, and the optical thickness (refraction rate times physical thickness) of each layer of the optical films results in phase difference. Specific phase difference is a necessary condition for generating optical interference. Through the overall thickness of the multilayer reflector 10, the material, and the extent of stretching during the manufacturing process, the optical characteristic can be varied, and so adjustment can be designed according to specific needs. The characteristic of the multilayer reflector 10 can be adjusted according to needs, such that via forming through single-axial or bi-axial stretching, the average transmittance rate of the multilayer reflector 10 for light spectrum 380˜780 nm can be selectively between 30% and 90%.

Furthermore, the multilayer reflector 10 can utilize single-axial or bi-axial stretching formation, so as to effectively adjust P and S polarization pattern ratio; or utilize just the bi-axial stretching formation to generate lights that have no polarization pattern. Furthermore a surface structure can be located on any surface of the inter-stacked polymer films 100 that forms the internal part of the multilayer reflector 10. The surface structure not only provides physical structure characteristics of additional functionality such as anti-sticking and anti-scratching, but may also include a photo-catalyst layer or a self-cleansing layer that provides corresponding functionalities, such that when light beams enter the photo-catalyst layer then harmful environmental substances can be broken down. Besides specialized functionality, another function provided by locating a surface structure is to provide optical utility, such as providing structures that is prism shaped, pyramid shaped, hemisphere shaped, aspheric shaped, Fresnel lens shaped, or grating structured, or a combination thereof. Simply stated, by locating a surface structure on the surface of inter-stacked polymer films 100, the optical effects of convergence, blending, diffraction, and scattering can be generated.

During manufacturing process, especially while the multilayer reflector 10 is forming, the molecular chain and molecular orientation of the polymer internal structure can be varied through a stretching machine in a single-axial or bi-axial formation, so that its physical characteristic changes, and the parameter affecting the stretch formation includes stretching temperature, speed, scaling factor, contraction, formation path, and heat setting temperature and time.

If single-axial or bi-axial stretching formation is utilized, generally the scaling ratio of single-axial stretching is from 1.5 to 6 times, and possibly greater, which is dependent upon needs and film material. Therein the film material of the inter-stacked polymer films 100 includes polyethylene terephthalate (PET), polycarbonate (PC), tri-acetyl cellulose (TAC), polymethylmethacrylate (PMMA) particle, methylmethacrylate styrene (MS), polypropylene (PP), polystyrene (PS), polymethylmethacrylate (PMMA), cyclic olefin copolymer (COC), polyethylene naphthalate (PEN), ethylene-tetrafluoroethylene (ETFE), polylactide (PLA), or a mix or polymerization of these materials thereof. Those optical elements formed via single-axial stretching formation can have specific directional polarization effect, thereby be used to adjust polarized wavelength range for light.

If bi-axial stretching formation is utilized, the scaling factor for each axial can be different, and the stretching formation can be according to sequence or both axial simultaneously, so that besides able to adjust for wavelength range, P and S polarization pattern ratio of light passing through multilayer reflector 10 can also be managed, such that adjustment can be made to near non-polarized condition.

Referring to FIG. 1C, the first embodiment of the instant disclosure provides a method of manufacturing a vehicle display mirror, comprising the steps of: (A) forming at least one multilayer reflector 10 composed of a plurality of inter-stacked polymer films 100 by a co-extruding process, wherein at least one of the inter-stacked polymer films 100 is a birefringence material layer that conforms to the condition of NX≠NY≠NZ, wherein NX is the index of refraction of light at X direction, NY is the index of refraction of light at Y direction, and NZ is the index of refraction of light at Z direction (S100); (B) extending the multilayer reflector 10 (S102); (C) respectively placing a first functional layer 11A and a second functional layer 11B on a first surface and a second surface of the multilayer reflector 10 to form a light-polarizing reflection unit 1 (S104); (D) adjusting the size of the light-polarizing reflection unit 1 to conform to the size of an image display screen 20 by cutting (S106); and then (E) adhesively placing the light-polarizing reflection unit 1 (its size has conformed to the size of an image display screen 20) on the image display screen 20 (S108).

Furthermore, FIG. 1D shows a schematic diagram of the method for manufacturing a multi-layer structure according to the instant disclosure. A multi-layer extrusion process is particularly used to form a multi-layer substrate. As shown in the diagram, the materials are used to form the multiple layers via different feeding regions. In the preferred embodiment, the materials are separately fed via the primary feeding region D1 and the secondary feeding region D2, and then a screw rod D3 and a heater D4 disposed on the feeding region are used to blend the materials. The materials have high selectivity. The material in each layer can be different. In a specific layer, the transparent diffusing beads are doped. Further, the materials are simultaneously under the blending-refine process on the feeding machine. Through the extrusion process at the mold head D5, the substrate with a certain thickness is obtained. After the modulation by the rolls D6, the thickness can be adjusted. After that, the surface structure is formed on one surface or both above and below surfaces. At last step of cooling through the cooling plate D7, the materials are solidified. The examination machines D8 can be used to examine the final product.

According to one of the embodiments of the instant disclosure, the multilayer reflector 10 is formed by a plurality of composite materials after repeatedly stacking in the co-extrusion procedure. The variant refractive indexes and thicknesses of the multilayer reflector 10 formed by multiple types of high-polymer meet the condition of optical interference that cause the light polarized and reflected. Since the interference condition is seriously defined, the coating technology used for the general optical lens often require multiple layers with high and low refractive indexes, such as dozen or hundred layers. In the instant disclosure, the multilayer reflector 10 can increase the reflectivity of polarized light by producing multiple times of interfered reflection through the multiple layers with high and low refractive indexes. That will be like the mentioned interference made by plural films. The multilayer reflector 10 will have better reflectivity to a certain wavelength when the multilayer reflector 10 has more layers stacked and better evenness control for higher variations of the refractive indexes. For example, the current embodiment repeatedly stacks the PET and PEN materials to form an (AB)ⁿ structure in the co-extrusion process. In which, n is an integer which is ranged within 10 to 500 based on the design, and the preferred value is within 120 through 180. When the temperature in the stretch procedure is controlled just as the anisotropy of the birefringence of the material happens, that is to make the refractive indexes of anisotropic and isotropic films change, and meanwhile the thickness with one-quarter wavelength is also employed, it is to accomplish the interference of multi-layer.

### Second Embodiment

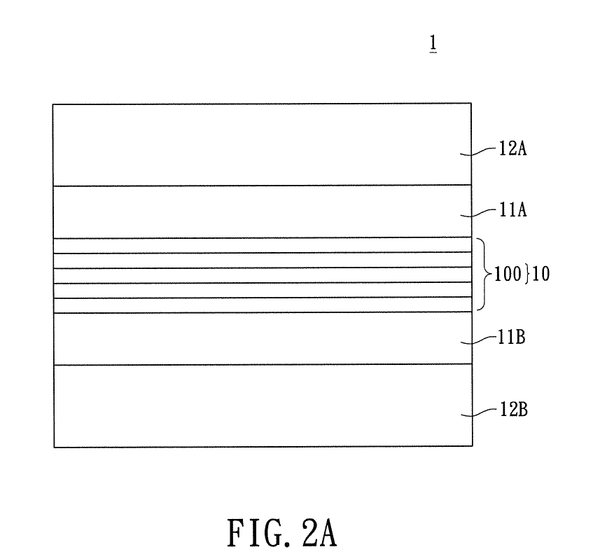

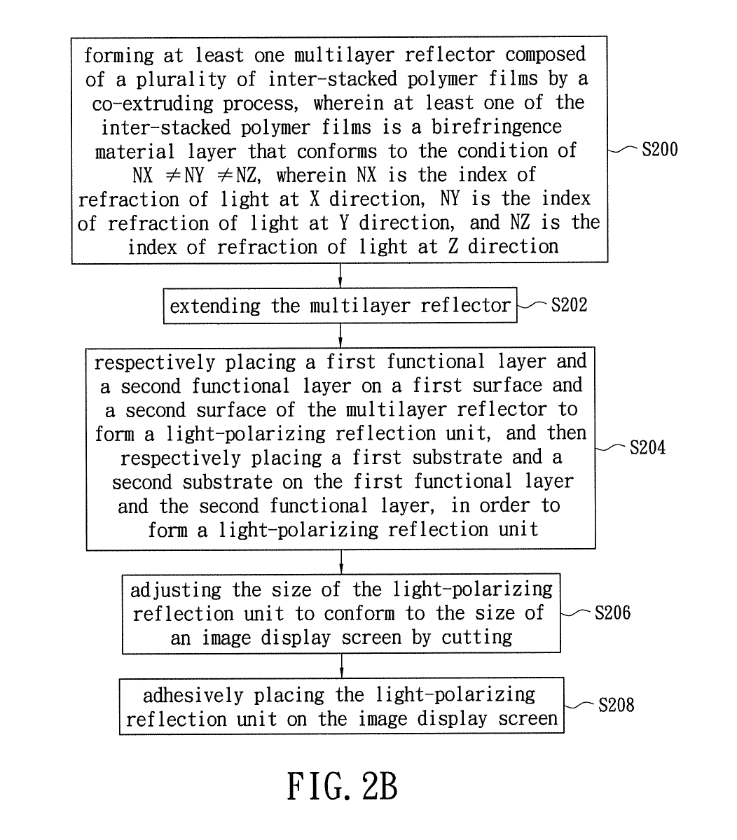

Referring to FIG. 2A, the second embodiment of the instant disclosure provides a vehicle display mirror M, which includes: a light-polarizing reflection unit 1 and an image display unit (not shown). Comparing FIG. 2A with FIG. 1A, the difference between the second embodiment and the first embodiment is as follows: in the second embodiment, the light-polarizing reflection unit 1 further includes a first substrate 12A and a second substrate 12B respectively disposed on the first functional layer 11A and the second functional layer 11B. For example, the first substrate 12A and the second substrate 12B are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

Referring to FIG. 2B, the second embodiment provides a method of manufacturing a vehicle display mirror, comprising the steps of: (A) forming at least one multilayer reflector 10 composed of a plurality of inter-stacked polymer films 100 by a co-extruding process, wherein at least one of the inter-stacked polymer films 100 is a birefringence material layer that conforms to the condition of NX≠NY≠NZ, wherein NX is the index of refraction of light at X direction, NY is the index of refraction of light at Y direction, and NZ is the index of refraction of light at Z direction (S200); (B) extending the multilayer reflector 10 (S202); (C) respectively placing a first functional layer 11A and a second functional layer 11B on a first surface and a second surface of the multilayer reflector 10 to form a light-polarizing reflection unit 1, and then respectively placing a first substrate 12A and a second substrate 12B on the first functional layer 11A and the second functional layer 11B, in order to form a light-polarizing reflection unit 1 (S204); (D) adjusting the size of the light-polarizing reflection unit 1 to conform to the size of an image display screen 20 by cutting (S206); and then (E) adhesively placing the light-polarizing reflection unit 1 (its size has conformed to the size of an image display screen 20) on the image display screen 20 (S208).

### Third Embodiment

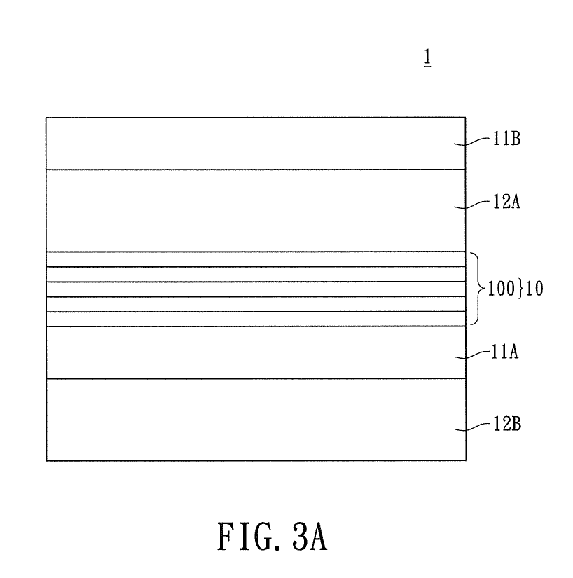

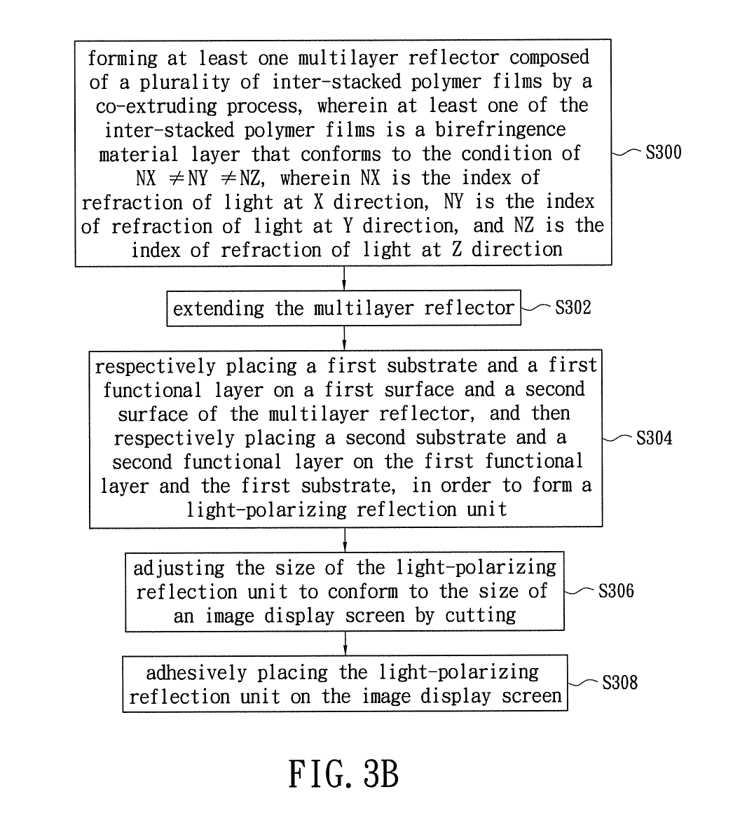

Referring to FIG. 3A, the third embodiment of the instant disclosure provides a vehicle display mirror M, which includes: a light-polarizing reflection unit 1 and an image display unit (not shown). Comparing FIG. 3A with FIG. 1A, the difference between the third embodiment and the first embodiment is as follows: in the third embodiment, the first substrate 12A and the first functional layer 11A are respectively disposed on a first surface and a second surface of the multilayer reflector 10, and the second substrate 12B and the second functional layer 11B are respectively disposed on the first functional layer 11A and the first substrate 12A.

Referring to FIG. 3B, the third embodiment provides a method of manufacturing a vehicle display mirror, comprising the steps of: (A) forming at least one multilayer reflector 10 composed of a plurality of inter-stacked polymer films 100 by a co-extruding process, wherein at least one of the inter-stacked polymer films 100 is a birefringence material layer that conforms to the condition of NX≠NY≠NZ, wherein NX is the index of refraction of light at X direction, NY is the index of refraction of light at Y direction, and NZ is the index of refraction of light at Z direction (S300); (B) extending the multilayer reflector 10 (S302); (C) respectively placing a first substrate 12A and a first functional layer 11A on a first surface and a second surface of the multilayer reflector, and then respectively placing a second substrate 12B and a second functional layer 11B on the first functional layer and the first substrate, in order to form a light-polarizing reflection unit 1 (S304); (D) adjusting the size of the light-polarizing reflection unit 1 by cutting to conform to the size of an image display screen 20 (S306); and (E) adhesively placing the light-polarizing reflection unit 1 on the image display screen 20 (S308).

### Fourth Embodiment

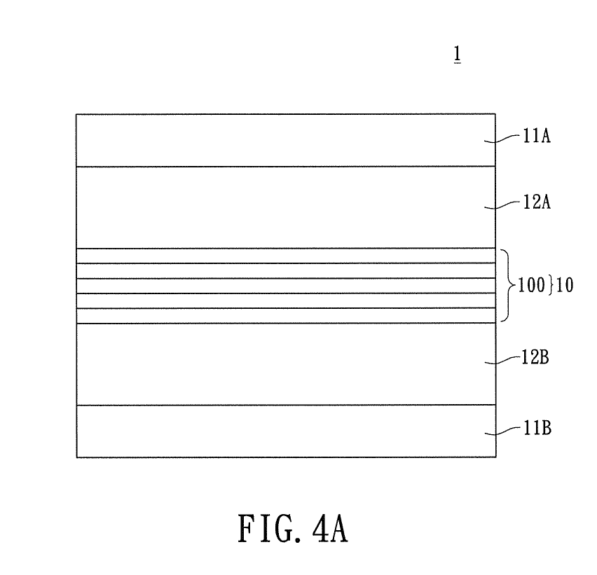

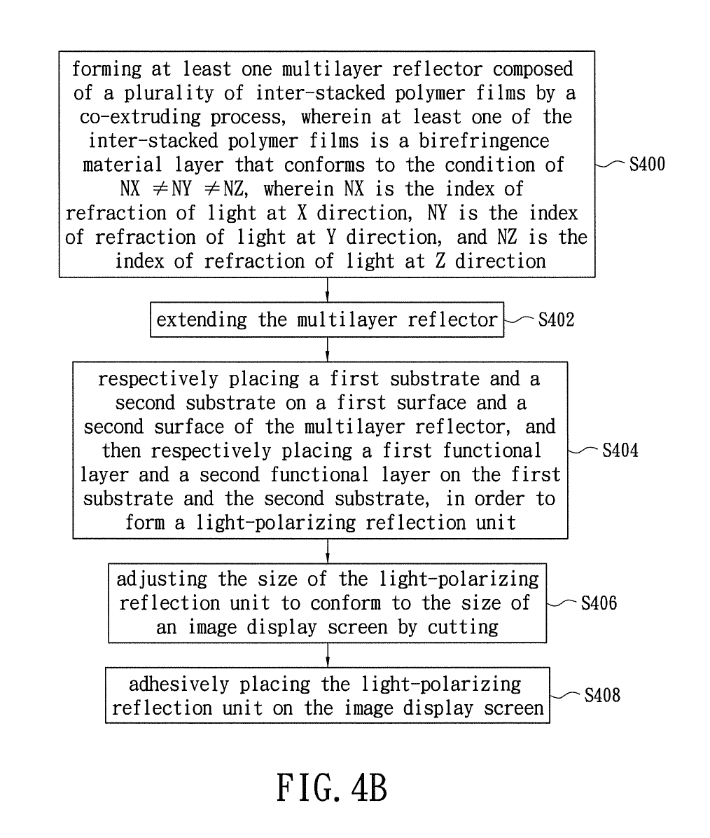

Referring to FIG. 4A, the fourth embodiment of the instant disclosure provides a vehicle display mirror M, which includes: a light-polarizing reflection unit 1 and an image display unit (not shown). Comparing FIG. 4A with FIG. 1A, the difference between the fourth embodiment and the first embodiment is as follows: in the fourth embodiment, the first substrate 12A and the second substrate 12B are respectively disposed on a first surface and a second surface of the multilayer reflector 10, and the first functional layer 11A and the second functional layer 11B are respectively disposed on the first substrate 12A and the second substrate 12B.

Referring to FIG. 4B, the fourth embodiment provides a method of manufacturing a vehicle display mirror, comprising the steps of: (A) forming at least one multilayer reflector 10 composed of a plurality of inter-stacked polymer films 100 by a co-extruding process, wherein at least one of the inter-stacked polymer films 100 is a birefringence material layer that conforms to the condition of NX≠NY≠NZ, wherein NX is the index of refraction of light at X direction, NY is the index of refraction of light at Y direction, and NZ is the index of refraction of light at Z direction (S400); (B) extending the multilayer reflector 10 (S402); (C) respectively placing a first substrate 12A and a second substrate 12B on a first surface and a second surface of the multilayer reflector 10, and then respectively placing a first functional layer 11A and a second functional layer 11B on the first substrate 12A and the second substrate 12B, in order to form a light-polarizing reflection unit 1 (S404); (D) adjusting the size of the light-polarizing reflection unit 1 by cutting to conform to the size of an image display screen 20 (S406); and (E) adhesively placing the light-polarizing reflection unit 1 on the image display screen 20 (S408).

In conclusion, the at least one multilayer reflector composed of the inter-stacked polymer films can be disposed on the image display screen, thus the vehicle display mirror of the instant disclosure can be used as a rear-view mirror of the vehicle and provide a clear displayed screen for user in the vehicle. Furthermore, at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A vehicle display mirror, comprising:
a light-polarizing reflection unit including at least one multilayer reflector composed of a plurality of inter-stacked polymer films, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction; and
an image display unit including at least one image display screen, wherein the at least one multilayer reflector is disposed on the at least one image display screen.

2. The vehicle display mirror of claim 1, wherein the light-polarizing reflection unit includes a first functional layer and a second functional layer respectively disposed on a first surface and a second surface of the at least one multilayer reflector.

3. The vehicle display mirror of claim 2, wherein the light-polarizing reflection unit includes a first substrate and a second substrate respectively disposed on the first functional layer and the second functional layer.

4. The vehicle display mirror of claim 3, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

5. The vehicle display mirror of claim 1, wherein the light-polarizing reflection unit includes a first substrate, a second substrate, a first functional layer, and a second functional layer, the first substrate and the first functional layer are respectively disposed on a first surface and a second surface of the at least one multilayer reflector, and the second substrate and the second functional layer are respectively disposed on the first functional layer and the first substrate.

6. The vehicle display mirror of claim 5, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

7. The vehicle display mirror of claim 1, wherein the light-polarizing reflection unit includes a first substrate, a second substrate, a first functional layer, and a second functional layer, the first substrate and the second substrate are respectively disposed on a first surface and a second surface of the at least one multilayer reflector, and the first functional layer and the second functional layer are respectively disposed on the first substrate and the second substrate.

8. The vehicle display mirror of claim 7, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

9. A method of manufacturing a vehicle display mirror, comprising the steps of:
(A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction;
(B) extending the at least one multilayer reflector;
(C) respectively placing a first functional layer and a second functional layer on a first surface and a second surface of the at least one multilayer reflector to form a light-polarizing reflection unit;
(D) adjusting the size of the light-polarizing reflection unit to conform to the size of an image display screen by cutting; and
(E) adhesively placing the light-polarizing reflection unit on the image display screen.

10. The method of claim 9, wherein after the step (C), the method further comprises: respectively placing a first substrate and a second substrate on the first functional layer and the second functional layer.

11. The method of claim 10, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

12. A method of manufacturing a vehicle display mirror, comprising the steps of:
(A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction;
(B) extending the at least one multilayer reflector;
(C) respectively placing a first substrate and a first functional layer on a first surface and a second surface of the at least one multilayer reflector, and then respectively placing a second substrate and a second functional layer on the first functional layer and the first substrate, in order to form a light-polarizing reflection unit;
(D) adjusting the size of the light-polarizing reflection unit to conform to the size of an image display screen by cutting; and
(E) adhesively placing the light-polarizing reflection unit on the image display screen.

13. The method of claim 12, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).

14. A method of manufacturing a vehicle display mirror, comprising the steps of:
(A) forming at least one multilayer reflector composed of a plurality of inter-stacked polymer films by a co-extruding process, wherein at least one of the inter-stacked polymer films is a birefringence material layer that conforms to the condition of NX≠NY≠NZ, wherein NX is the index of refraction of light at X direction, NY is the index of refraction of light at Y direction, and NZ is the index of refraction of light at Z direction;
(B) extending the at least one multilayer reflector;
(C) respectively placing a first substrate and a second substrate on a first surface and a second surface of the at least one multilayer reflector, and then respectively placing a first functional layer and a second functional layer on the first substrate and the second substrate, in order to form a light-polarizing reflection unit;
(D) adjusting the size of the light-polarizing reflection unit to conform to the size of an image display screen by cutting; and
(E) adhesively placing the light-polarizing reflection unit on the image display screen.

15. The vehicle display mirror of claim 14, wherein the first functional layer and the second functional layer are one of a metal oxide layer or an ultraviolet absorbing layer, and the first substrate and the second substrate are selected from the group consisting of polyethylene terephthalate (PET), poly carbonate (PC), polyethylene (PE), poly vinyl chloride (PVC), poly propylene (PP), poly styrene (PS), and polymethylmethacrylate (PMMA).
